(19) United States
(12) Patent Application Publication
(10) Pub. No.: US 2013/0167416 A1
(43) Pub. Date: Jul. 4, 2013

(54) STRETCHABLE WRIST BANDS INCLUDING MEDICAL INFORMATION

(71) Applicants: Kordel Carson BRAZELL, West Columbia, SC (US); James Walter HANCOCK, West Columbia, SC (US)

(72) Inventors: Kordel Carson BRAZELL, West Columbia, SC (US); James Walter HANCOCK, West Columbia, SC (US)

(21) Appl. No.: 13/769,531

(22) Filed: Feb. 18, 2013

Related U.S. Application Data
(63) Continuation-in-part of application No. 13/247,462, filed on Sep. 28, 2011.

(51) Int. Cl. G09F 3/00

(52) U.S. Cl. CPC G09F 3/005
USPC 40/633

(57) ABSTRACT

A stretchable wrist band includes a message printed on an outer portion thereof, wherein the message is indecipherable when the wrist band is in its relaxed state, but the message may be read when the wrist band is stretched out. The wrist bands may also include pictures or designs, rather than (or along with) text, and the pictures or designs may only be properly perceived when the wrist band is in the stretched state. In one embodiment, the stretchable wrist band may include private or confidential medical information about the wearer, which may be accessed by medical personnel or first responders in the event of a medical emergency or incident by stretching the band to a stretched state in order to read the medical information.

### RELATED APPLICATIONS

This patent application is a continuation-in-part of U.S. application Ser. No. 13/247,462, filed on Sep. 28, 2011.

### BACKGROUND OF THE INVENTION

The present invention relates generally to ornamental, stretchable wrist bands that include messages on an outer portion thereof. More specifically, the present invention includes a stretchable wrist band with a message printed on the outside, wherein the message is printed or affixed to the wrist band in such a way that the message may only be read and perceived while the wrist band is in a stretched out state. In one embodiment, the information or message on the stretchable wrist band may include medical information, wherein the information would not be readily legible in an unstretched state, but could be seen in the event of an emergency by stretching the band into a stretched state.

There are currently a variety of commercially available ornamental wrist bands in existence. For example, framed cyclist Lance Armstrong set up a charity that sells elastic wrist bands emblazoned with the words LIVE STRONG, in order to raise awareness of cancer. Other types of stretchable wrist bands include inspirational messages, such as LOVE, PERSEVERANCE, DEDICATION, etc. Still other types of stretchable wristbands are formed into various shapes in the unstretched state, such as shapes of animals, under the brand name SILLY BANDZ.

U.S. Pat. No. 4,499,741, issued to Harris, discloses a stretchable knitted article of predominately terry loop construction with a design printed thereon. The design is printed on the plain region whereby it maintains its definition and continuity of appearance when stretched in ordinary use.

U.S. Pat. No. 4,918,758, issued to Rendina, is directed to a changeable message stretch band, which allows the wearer to communicate words and expressions via the use of removably attached graphics, including letters, numerals, designs and the like, in a combination selected by the wearer, whereby the wearer may change the message on the stretch band.

U.S. patent application Ser. No. 11/481,329, for Cummiskey, et al., describes a customizable elastic band including a means for coupling at least one secondary component thereto, wherein the secondary component is adapted to individualize the elastic band. The secondary component includes a printed message, a design, or combination thereof, and may further include electronic circuitry which is adapted to interact with a point of sale system.

U.S. patent application Ser. No. 12/825,988, for Farmer, et al., discloses a bracelet for displaying messages including a continuous elastic band and at least one releasably attached message clip. The clip portion is connected to the body for releasably holding the body on the band, and a message portion is attached to the clip.

It would be desirable, however, to provide stretchable wrist bands that included secret messages that could only be read when the wrist band is in its stretched state. These elastic wrist bands, when in the unstretched state, appear to have an indecipherable design, which can only be deciphered by stretching the wrist band and reading the hidden message. It would further be desirable to include confidential, important medical information that pertains to the wearer, so that such medical information could be readily accessed in the event of a medical emergency.

### BRIEF SUMMARY OF THE INVENTION

In accordance with one aspect of the invention, a stretchable wrist band is provided. The wrist band includes a message printed on an outer portion thereof, wherein the message is indecipherable when the wrist band is in its relaxed state, but the message may be read when the wrist band is stretched out. The wrist bands may also include pictures or designs, rather than (or along with) text, and the pictures or designs may only be properly perceived when the wrist band is in the stretched state.

The wrist bands may be manufactured by stretching the wrist band and printing, engraving, or otherwise applying the message or design to the band while it is in the stretched state. Then, when the band is allowed to return to its relaxed state, the message or design simply looks like an unreadable or random design.

In another embodiment of the present invention, medical information may be printed on the stretchable wrist band, together with a medical symbol, so that in a medical emergency, medical personnel may be able to stretch the wristband and obtain valuable medical information helpful in treating the victim. Such medical information may include medical conditions that the wearer has, prescription or other medication that the wearer is currently taking, information regarding allergies to certain medications, such as penicillin, and other helpful or related medical information.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a stretchable wrist band positioned on the wrist of a wearer, wherein the band is in its stretched state and the message “BE MY VALENTINE” is legible on an outer portion thereof; and

FIG. 2 is a perspective view of the stretchable wrist band illustrated in FIG. 1, wherein the wrist band is positioned on the wrist of a wearer, and wherein the wrist band is in its relaxed state and the message is illegible.

### DETAILED DESCRIPTION OF THE INVENTION

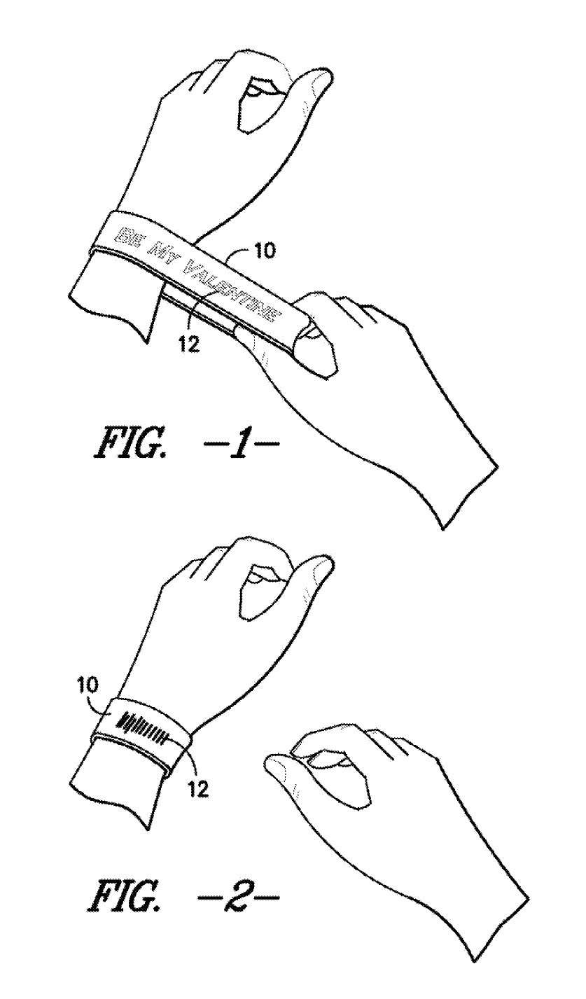

The present invention includes, in a first embodiment, a continuous, stretchable wrist band 10 having a message 12 printed on an outer portion thereof, wherein the message 12 is indecipherable when the wrist band 10 is in its relaxed state, but the message 12 may be read when the wrist band 10 is stretched out. FIG. 1 shows a wrist band 10 in accordance with one aspect of the present invention, wherein the wrist band 10 is in its stretched state, and wherein the printed message 12 “BE MY VALENTINE” is clearly legible. FIG. 2 shows the wrist band 10 that is illustrated in FIG. 1, wherein the wrist band 10 is in its relaxed state (or “non-stretched” state), and the message 12 is illegible, appearing as a random or indecipherable design.

It is contemplated that the present wrist bands 10 may be used, particularly by children, as a novelty item. A person may give a wrist band 10 with a secret or hidden message 12 to a friend or acquaintance. In order to read the message 12, the receiving party must stretch the wrist band 10 so that the message 12 becomes legible and decipherable. Additionally, the stretchable wrist bands 10 may include a picture or other ornamental design that may only be perceived when the wrist band 10 is in its stretched state.

The wrist bands 10 may be made from any suitable stretchable material. One method for manufacturing the stretchable wrist bands 10 with the hidden messages 12 includes the steps of providing a stretchable wrist band 10, stretching the wrist band 10 to its stretched state (defined as stretched to approximately the elastic limit of the wrist band without breaking or otherwise weakening the band itself) and printing or engraving any desired message 12 or design. Then, when the message 12 or design has been properly printed, engraved, or otherwise affixed to the stretched wrist band 10, the wrist band 10 is allowed to return to the relaxed state, in which the message 12 or design contracts into an unintelligible pattern.

The wrist bands 10 may be printed with a number of different “stock” messages 12, such as BE MY VALENTINE, FRIENDS FOREVER, or any other desired message 12. Alternatively, the wrist bands 10 may be custom manufactured, so that a customer may choose his own message 12 or design of limited size or length, and place an order. Once the order is received by the wrist band manufacturer, the message 12 or design chosen by the customer may be printed on a single or multiple wrist bands 10, which are then delivered to the customer.

It is contemplated that the wrist bands 10 may be used as promotional items by businesses, wherein the business name is printed on the secret wrist bands. The bands 10 may be made of different colors, may include logos of popular sports teams, and may even include glow-in-the-dark material, so that the bands and their hidden messages may glow in the dark. The wrist bands 10 may be used for any other purpose, as well. For instance, a person may desire to have some wrist bands 10 printed with his telephone number or email address, so that the person may hand out the wrist bands 10 with this information to business associates, or even members of the opposite sex, in order to convey contact information.

In another aspect of the present invention, kits may be sold, allowing a person to purchase multiple wrist bands 10 and print their own desired message 12 onto the wristband. The kit may consist of a number of elastic wrist bands 10, and an adjustable ink stamp that may be used to stamp the ink message onto the wrist band 10 while the wrist band 10 is secured in its stretched state. Adjustable ink stamps are commercially available and well-known in the art. These adjustable ink stamps typically include a series of rotating wheels or tracks, wherein each track includes a series of letters and/or numbers. A user can rotate each track, choosing any desired letter or number, in order to formulate the desired message 12. When the message 12 is properly aligned on the adjustable ink stamp, the stamp may be pressed onto an ink pad, and then applied to an outer portion of the wrist band 10 in its stretched state.

In another embodiment of the present invention, medical information may be printed on (or otherwise affixed to) the stretchable wrist band, so that in a medical emergency, medical personnel will have access to information they may need to help treat the victim. Such medical information may include the wearer's medical condition(s), prescription drugs or other medication that the wearer is currently taking, allergies, their doctor's name and/or contact information, or any other medical information that may be useful if the wearer is involved in some type of medical emergency. In order to alert the medical personnel that the wrist band includes valuable medical information, the stretchable wrist band may include a medical symbol or other indication that the wrist band contains medical information. In one embodiment, the medical information may be printed on the band in such a way that the wrist band need not be stretched in order to read or decipher the information, so that it is readily legible when the band is in the unstretched, or relaxed state. In another embodiment of the invention, the medical information may be printed on the wrist band so that the wrist band must be stretched in order to make the information legible. One advantage to this arrangement is that medical information is typically confidential and private, and if a wearer is wearing a band that must be stretched out in order to view the medical information, then the information stays largely private during normal daily use.

The medical version of the stretchable wrist band may be sold with pre-printed information for wearers with common conditions, such as certain allergies, diabetes, epilepsy, and the like. Additionally, for less common conditions or information, the bands may be customized, so that a person may specify exactly what type of information needs to be included on the wrist band. Other information may be included, as well, including a person's blood type, next of kin contact information, or even status as an organ donor. For additional privacy, the medical symbol may be located on an outer side of the band, while the actual information may be printed on an underside thereof, so that the medical information is not visible during normal daily use, but may be easily gleaned by flipping the wristband inside-out to view the information. Although the present invention is described generally as a stretchable wrist band, it is contemplated that the stretchable band could be worn on other areas of a wearer's body, such as a wearer's ankle.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A stretchable wrist band comprising:
an elastic loop including medical information about a wearer on one side thereof, wherein said medical information may be perceived when said elastic loop is in a stretched state, and wherein said medical information may be seen, but not perceived, when said elastic loop is in a relaxed state.

2. The stretchable wrist band set forth in claim 1, wherein said elastic loop is a continuous loop.

3. The stretchable wrist band set forth in claim 1, further including a medical symbol printed on or attached to one side of said stretchable wrist band.

4. The stretchable wrist band set forth in claim 3, wherein said medical symbol is printed on or attached to a first side thereof, and said medical information is printed on an opposed side thereof.

5. A wrist band comprising
a generally flat loop of material having a first side and a second side;
medical information printed or engraved on one side thereof, wherein said wrist band may be worn so that said side of said wrist band including said medical information may be oriented outwardly, so that the medical information faces away from a wearer's skin and wrist, or may be worn so that said side of said wrist band including said medical information may be oriented inwardly, so that the medical information faces toward a wearer's skin and wrist.

6. The wrist band set forth in claim 5, further including a medical symbol shown on one side thereof, indicating that the wrist band includes medical information.

7. The wrist band set forth in claim 6, wherein said medical symbol is shown on an opposed side of said wrist band from said side including said medical information.

8. A method for providing medical information to an emergency medical worker, the method comprising the steps of:
providing a stretchable band that may be worn on a wearer's wrist or ankle, wherein said stretchable band comprises an elastic loop having medical information about said wearer on one side thereof, and wherein said medical information may be perceived when said elastic loop is in a stretched state, and wherein said medical information may be seen, but not perceived, when said elastic loop is in a relaxed state;
receiving, on a wearer's body, particularly on a wrist or ankle, said stretchable band; and
stretching, by a medical worker or first aid responder, said stretchable band in order to read said medical information in the event of a medical emergency or incident.

9. The method set forth in claim 8, including the step of providing a medical symbol printed on or attached to one side of said stretchable wrist band, wherein said medical symbol may be perceived when said stretchable band is in a relaxed state or a stretched state.

10. The method set forth in claim 9, including the step of providing said medical symbol on or attached to a first side thereof, and printing or attaching said medical information on an opposed side thereof.
